(19) United States
(12) Patent Application Publication
(10) Pub. No.: US 2013/0239330 A1
(43) Pub. Date: Sep. 19, 2013

(54) SYSTEMS AND DEVICES FOR MONITORING OF ASSEMBLY CONFIGURATIONS AND CONDITIONS

(71) Applicant: INVACARE CORPORATION, Elyria, OH (US)

(72) Inventor: Douglas J. Newlin, Wheaton, IL (US)

(73) Assignee: INVACARE CORPORATION, Elyria, OH (US)

(21) Appl. No.: 13/785,462

(22) Filed: Mar. 5, 2013

Related U.S. Application Data
(60) Provisional application No. 61/608,793, filed on Mar. 9, 2012.

(51) Int. Cl. A61G 7/002

(52) U.S. Cl. CPC A61G 7/002
USPC 5/600; 340/679

(57) ABSTRACT

An assembly monitoring system includes a receiver, an assembly, and a processor. The assembly includes at least one trackable component including a transmitter configured to deliver component identifying data to the receiver. The processor is in electronic communication with the receiver and stores authorized assembly configuration data associated with at least one authorized component. The processor is configured to receive the component identifying data from the receiver and to compare the component identifying data with the authorized assembly configuration data. The processor is further configured to generate a first improper assembly signal when the component identifying data does not correspond to at least a portion of the authorized assembly configuration data.

### CROSS-REFERENCE TO RELATED APPLICATION

This application claims priority to and the benefit of U.S. Provisional Patent Application Ser. No. 61/608,793, entitled “SYSTEMS AND DEVICES FOR MONITORING OF ASSEMBLY CONFIGURATIONS AND CONDITIONS” and filed Mar. 9, 2012, the entire disclosure of which is incorporated herein by reference.

### BACKGROUND

Many assemblies such as, for example, electrically powered adjustable beds, require assembly with properly sized and/or adequately maintained components to assure safe, reliable operation of the assembly. In the case of an adjustable bed, for example, an improperly sized or over-worn mattress can result in gaps between the mattress and bed frame that present entrapment risks for users of the bed, particularly for disabled or elderly individuals.

### SUMMARY

The present application discloses exemplary systems for monitoring assembly and maintenance configurations and conditions, for example, to facilitate use of proper or compatible components or properly maintained components. In one exemplary embodiment, an adjustable bed includes a monitoring system for verifying use of proper components and/or properly maintained (e.g., within an acceptable service life) components.

Accordingly, in an exemplary embodiment, an assembly monitoring system includes a receiver, an assembly, and a processor. The assembly includes at least one trackable component including a transmitter configured to deliver component identifying data to the receiver. The processor is in electronic communication with the receiver and stores authorized assembly configuration data associated with at least one authorized component. The processor is configured to receive the component identifying data from the receiver and to compare the component identifying data with the authorized assembly configuration data. The processor is further configured to generate a first improper assembly signal when the component identifying data does not correspond to at least a portion of the authorized assembly configuration data.

In another exemplary embodiment, a method for monitoring an assembly is disclosed. In the method, component identifying data is received from a transmitter associated with a first trackable component of the assembly. The component identifying data is delivered to a processor. The component identifying data is compared to authorized assembly configuration data associated with an authorized component. A first improper assembly signal is generated when the component identifying data does not correspond to the authorized assembly configuration data.

In still another exemplary embodiment, an electrically powered adjustable bed assembly includes first and second side rails, an end board assembled with end portions of the first and second side rails, and a mattress. A first transmitter is assembled with one of the first side rail, the second side rail, the end board, and the mattress. The first transmitter is configured to deliver a first wireless signal communicating first component identifying data including at least one of a serial code, date code, product part number, and date of first use of the one of the first side rail, the second side rail, the end board, and the mattress.

### BRIEF DESCRIPTION OF THE DRAWINGS

Further features and advantages will become apparent to those of ordinary skill in the art to which the invention pertains from a reading of the following description together with the accompanying drawings, in which:

FIG. 1 is a schematic illustration of an assembly monitoring system for identifying improper use or maintenance of an assembly, according to an exemplary embodiment;

FIG. 1A is a schematic illustration of another assembly monitoring system for identifying improper use or maintenance of an assembly, according to another exemplary embodiment;

FIG. 2 is a block diagram illustrating a method of monitoring assembly and maintenance of an assembly, according to an exemplary embodiment;

FIG. 3 is a schematic illustration of an electrically powered adjustable bed with a monitoring system for identifying improper use or maintenance of the bed, according to an exemplary embodiment; and

FIG. 4 is a block diagram illustrating a method of monitoring assembly and maintenance of an electrically powered adjustable bed, according to an exemplary embodiment.

### DESCRIPTION

This Description merely describes exemplary embodiments and is not intended to limit the scope of the claims in any way. Indeed, the invention as claimed is broader than and unlimited by the exemplary embodiments, and the terms used in the claims have their full ordinary meaning

As described herein, when one or more components are described as being electronically, electrically, or mechanically connected, joined, affixed, coupled, attached, or otherwise interconnected, such interconnection may be direct as between the components or may be indirect, such as through the use of one or more intermediary components. Also as described herein, reference to a “member,” “component,” or “portion” shall not be limited to a single structural member, component, or element but can include an assembly of components, members or elements.

Many different types of equipment and assemblies rely on assembly with proper components in adequate condition (e.g., not overly worn) for safe use, and may present hazardous or even life threatening conditions if incorrect or over-worn components are used. As one example, an adjustable bed used, for example, in a hospital, nursing home, or in-home care setting, may present entrapment points or pinch points between mismatched and/or worn bed components, particularly during adjustment (e.g, lifting and/or tilting) of the bed. For example, entrapment points may be created between the mattress and the side rails or end boards if an improperly sized (e.g., too narrow) or overly worn (e.g., excessively sagging) mattress is used.

The present application contemplates systems for identifying, restricting, and/or preventing potentially hazardous improper use of an electronically controlled assembly resulting from, for example, improper maintenance, use of incorrect components (e.g., improper size, configuration, compatibility, or materials, or suspect workmanship or quality), or excessive wear. As used herein, “excessive wear” may include wear at, near, or beyond a predetermined threshold, and may include actual measured wear (e.g., based on dimensional measurements) and/or predicted wear (e.g., based on cycle life or time in service). In one embodiment, an adjustable bed may include a monitoring system used to identify the inclusion or use of incorrect, outdated or overly worn bed components, such as the mattress, end boards, or side rails, that may make use and/or adjustment of the bed hazardous (for example, by creating pinch or entrapment points or gaps between the mattress and the side rails or between the side rails and the end boards). Such a monitoring system may provide an alert or prevent operation of the bed's lift mechanism (or other such operating mechanisms) in response to the identification of a missing, incorrect, outdated, or overly worn component. These are only illustrative examples and other safety related actions can also be taken with respect to these and other components.

In an exemplary embodiment, a monitoring system for an electronically controlled assembly includes a receiver in electronic communication (e.g., wired or wireless communication) with one or more components of the assembly. In addition to receiving a signal from the one or more components confirming the presence or proximity of that component, the receiver may also receive information from the one or more components regarding that component. For example, the receiver may receive information regarding the identity of the component (e.g., part number, serial number, manufacturer), the age of the component (e.g., date of manufacture, date placed into service), and/or the condition of the component (e.g., cycle life, measurable condition related to wear). To ensure that the data has not been improperly transmitted from an unauthorized component of, for example, suspect materials or workmanship provided with a transmitter configured to misidentify the unauthorized component, the receiver may be configured to send and receive suitably encrypted data signals (for example, using triple DES encryption or some other encryption), that are more difficult to improperly process and duplicate.

The information received by the receiver may be communicated to a processor for evaluation of the existence, status, and/or condition of the one or more components, and to prompt one or more operations of the monitoring system based on the information received. For example, the processor may be configured to generate one or more improper assembly signals when a missing component, incorrect component, outdated component, worn component, and/or improperly maintained component has been identified. In one embodiment, an improper assembly signal generates a warning or other indication (e.g., alarm sound, voice message, indicator light, textual message) of the detected condition. Additionally or alternatively, another improper assembly signal may function to disable one or more electromechanical functions of the assembly when a missing component, incorrect component, outdated component, worn component, and/or improperly maintained component has been identified, for example, to prevent any operation of the assembly that may be hazardous due to the worn, missing, or incorrect components. Furthermore, an improper assembly signal can be used to communicate such conditions and/or actions to other devices such as, for example, local or remote monitoring devices or stations for purposes of archival, notice, and/or remedial activity.

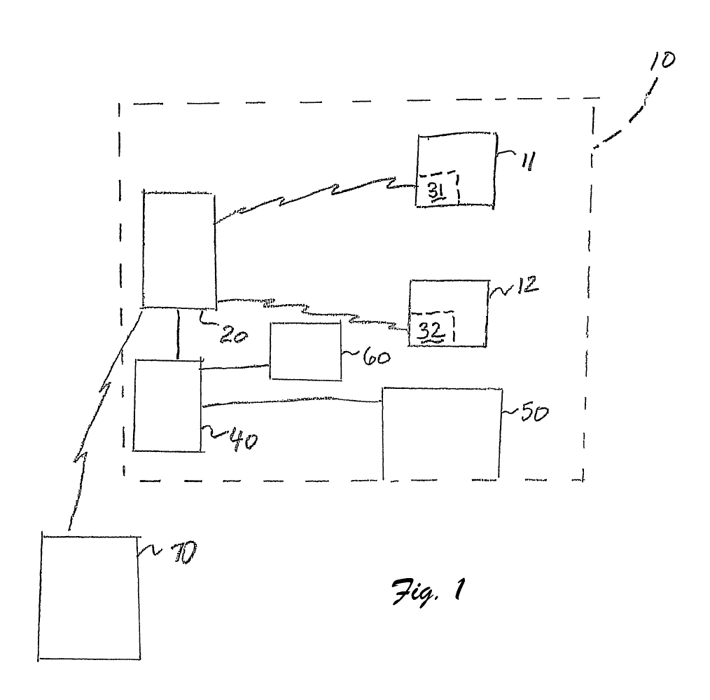

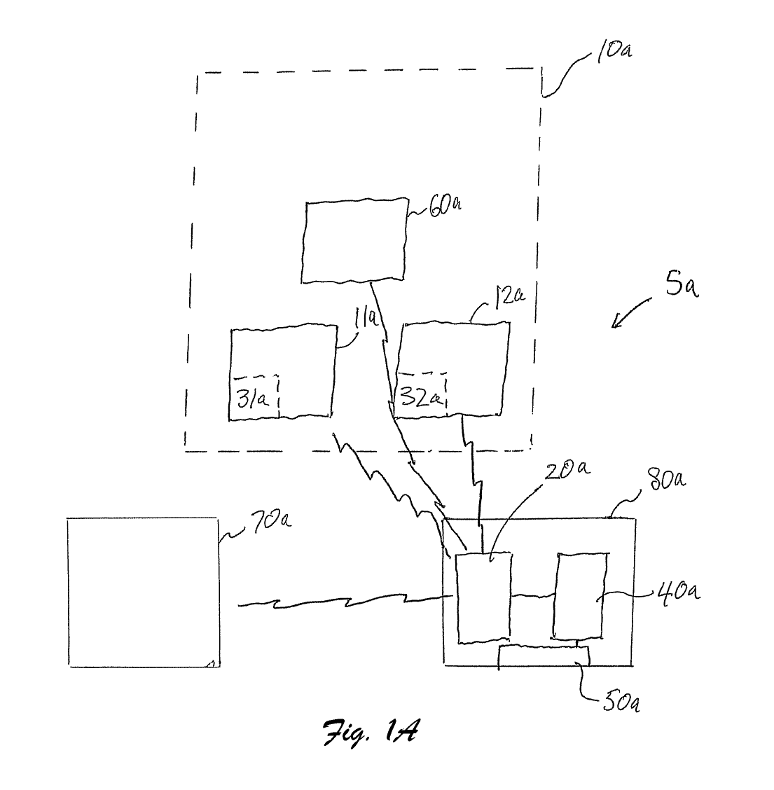

FIG. 1 schematically illustrates an exemplary system 5 for monitoring an assembly 10, for example, for identifying improper use, maintenance, and/or wear of the assembly. The exemplary assembly 10 includes a receiver 20 in electronic communication with one or more components 11, 12 of the assembly 10. While the components may be connected with the receiver 20 by wired connections, in an exemplary embodiment, each component 11, 12 includes a wireless transmitter 31, 32 attached to or embedded in the component, and configured to deliver a wireless data signal to the receiver 20, providing information about the component. Many different types of wireless communication between the transmitters 31, 32 and the receiver 20 may be utilized, including, for example, wireless communication utilizing one or more of WiFi (802.11), ZigBee (802.15), radio frequency identification (RFID) communication, infrared (IR) transmission, near field communication (NFC), Bluetooth®, or any other suitable wireless data protocol. In one embodiment, short range wireless communication (e.g., Bluetooth®, RFID, or NFC) may be utilized to prevent the receiver from receiving signals from components assembled with other assemblies.

While the transmitters 31, 32 may be configured to automatically provide continuous or intermittent data signals to the receiver 20, in one embodiment, the receiver may include a transceiver or transmitter-receiver configured to intermittently or selectively poll or interrogate the transmitters to obtain information from the transmitters regarding the corresponding components 30. In one such embodiment, the receiver 20 includes an RFID transceiver or reader and the transmitters 31, 32 include RFID tags attached to or embedded within the components 11, 12. The RFID reader 20 periodically (e.g., once per day), for example, as controlled by a processor and clock unit, generates and transmits an encoded radio frequency (RF) signal to RFID tags within range (e.g., 1-2 meters) or within an interrogation zone of the reader. The RFID tags 31, 32 within range of the reader receive and demodulate the signal, and modulate and transmit a response signal to the RFID reader, including object specific information. The RFID reader may be configured to singulate responses from multiple RFID tags within range using, for example, an adaptive binary tree protocol (successively targeting RFID tags with incremental serial numbers) or an ALOHA protocol (transmitting signals that cause the RFID tags to pseudo-randomly delay their responses). The monitoring system may use passive (powered by the interrogation signal), active (self powered), or battery assisted passive (battery activated in the presence of a reader) RFID tags. The RFID tags may be read-only, with manufacturer assigned serial numbers or product codes, or read/write and configured to be written with information pertaining to usage of the assembly or other data. The use of read-write RFID tags may allow information regarding use of the corresponding components to be stored in the tags (e.g., number of cycles/actuations, period of time in use), such that the corresponding component, if removed from the assembly and installed in a new assembly, may be recognized by the monitoring system of the new assembly as having been exposed to service conditions corresponding to the written usage information.

The response signals received by the RFID reader 20 may be delivered to a processor 40 to confirm the presence of assembly components 11, 12 within range of the reader 20, and to provide an indication of the type of component (e.g., part number, material code, manufacturer), age of the component (e.g., serial number, date code), and/or usage of the component (e.g., serial number in combination with cycle or service life data recorded by a processor of the assembly). The received data is delivered to processor 40 for comparison with stored data associated with the required components for the assembly. Based on this data, the processor may identify improper maintenance of the assembly, based on the absence of a response signal from one of the components of the assembly (indicating a missing component or an unauthorized component lacking an RFID tag), the receipt of an incorrect response signal from one of the components of the assembly (indicating misassembly with an incorrect component), or the receipt of a response signal associated with an old or outdated component or a component for which an excessive service or cycle life has been attributed. In an exemplary embodiment, the processor 40 may be in electronic communication (e.g., via a wireless Internet connection with the assembly 10 or with a portable diagnostic device connectable to the assembly) with a central computer 70 storing information related to component usage in other assemblies, to identify used components that have been removed from other assemblies and assembled with the assembly 10. The processor 40 may likewise upload usage information related to the components 30 to the central computer 70.

Based on a determination by the processor 40 of impending, overdue or improper maintenance of the assembly 10, the processor may deliver an improper assembly signal to a connected user interface 50, to generate, for example, an audible siren, chime, voice prompt or other warning through a speaker, a light, textual message or graphic signal on a display panel, or an e-mail, voice, or text message delivered through a connected computer. Information related to these warning (e.g., time, date, information conveyed, corrective action in response to warning).

As one example, the output signal may provide a notification that routine maintenance is needed soon, immediately, or is past due, for example, based on service/cycle life of a component as determined by information stored in the processor 40 (e.g., cycles or time period over which the processor has recognized the component in question as being part of the assembly) or in the transmitter 31, 32 (e.g., cycle or time period information written to the transmitter, during use of the assembly and any use of the component in another monitoring system based assembly). The condition of the component (and its need for maintenance or replacement) may be estimated based on historic performance (e.g., in service/cycle life) of comparable components.

As another example, the output signal may provide a notification that an incorrect component or combination of components is included in the assembly, based on part number, serial, number, or source identifying information stored in the transmitter and delivered to the receiver. The processor stores information regarding authorized combinations of components (e.g., combinations that have been validated or approved as safe). As new combinations of components become authorized or approved (e.g., through testing or analysis), information pertaining to these authorized combinations may be stored in the processor. As still another example, the improper assembly signal may provide notification that a component is either missing or of an unverified source or type, based on a failure of the receiver 20 to recognize or receive a signal from a transmitter associated with the component.

Additionally, where the assembly 10 includes one or more electrically powered or electromechanical operating mechanisms 60 designed to perform one or more electromechanical operations (which may, but need not, involve operation of the trackable components 11, 12), the processor 40 may be configured to disable or restrict at least one of the one or more electromechanical operating mechanisms 60 in response to the identification of overdue unperformed or improper maintenance of the assembly 10. This disabling/restricting may, for example, prevent hazardous usage resulting from the improper or unperformed maintenance, and/or may instigate more timely correction of the improperly maintained condition of the assembly. The system may include a text screen or speech unit prompting a user to confirm a suitable configuration or condition of the components. Additionally, the system may be configured to allow an override of any disabling or restriction of an operating mechanism (e.g., through entry of an administrator code). The processor may record information (e.g., time, date, user ID) pertaining to a verification of proper assembly or an overriding event, which may be retrieved, for example, in the event that the verification or override is later determined to be improper.

While the receiver 20, processor 40, and user interface 60 may be connected with, disposed within, or otherwise integrated into the assembly 10, as shown in FIG. 1, in another embodiment, one or more of a receiver, processor, and user interface may additionally or alternatively be integrated into a separate diagnostic device (e.g., a cellular telephone, smart phone, tablet computer, etc.). FIG. 1A schematically illustrates an exemplary system 5a for monitoring an assembly 10a similar to the system 5 of FIG. 1, except with a separate diagnostic device 80a including a receiver 20a, processor 40a, and user interface 50a. The exemplary system 5a allows an operator or administrator to monitor or confirm the proper assembly and or condition of the assembly 10a by receiving communication from the transmitters 31a, 32a, either remotely or when the diagnostic device 80a is brought into proximity with the assembly 10a.

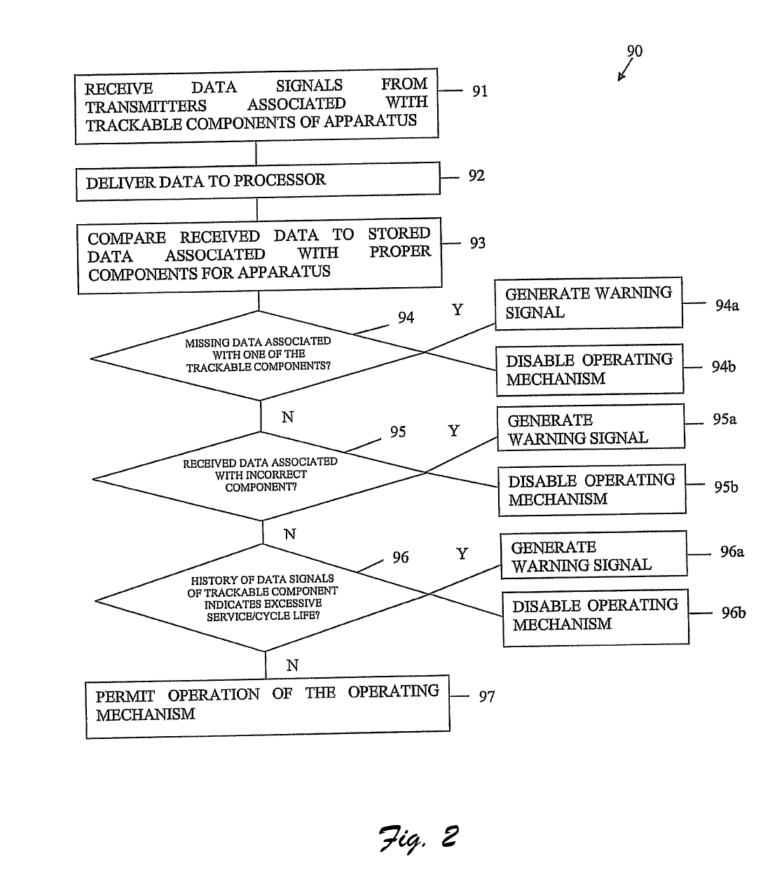

FIG. 2 is a block diagram illustrating an exemplary monitoring process or logic 90 for an electrically operated assembly provided with an assembly and/or maintenance monitoring system, for example, as described above. The rectangular elements denote “processing blocks” and represent computer software instructions or groups of instructions. The diamond shaped elements denote “decision blocks” and represent computer software instructions or groups of instructions which affect the execution of the computer software instructions represented by the processing blocks. The flow diagrams shown and described herein do not depict syntax of any particular programming language. Rather, the flow diagrams illustrate the functional information one skilled in the art may use to fabricate circuits or to generate computer software to perform the processing of the system. It should be noted that many routine program elements, such as initialization of loops and variables and the use of temporary variables are not shown. Furthermore, the exact order of the process steps need not necessarily be performed in the order shown or described herein and may be modified.

In block 91, a receiver receives data signals from transmitters associated with (e.g., embedded in or assembled with) one or more trackable components of the assembly. These data signals may, but need not, be received in response to polling or interrogation by the receiver, as described above. In block 92, the receiver delivers data obtained from the data signals to a processor. In block 93, the processor compares the received data to stored data associated with validated or proper components for the assembly. If the processor fails to receive data associated with one of the trackable components (as queried in block 94), the processor delivers an improper assembly signal to generate a warning signal (block 94a) and/or disables an operating mechanism of the assembly (block 94b). If the processor receives data associated with an improper or unvalidated trackable component (as queried in block 95), the processor delivers an improper assembly signal to generate a warning signal (block 95a) and/or disables the operating mechanism of the assembly (block 95b). Additionally or alternatively, if the processor receives data for a proper or validated component, the processor may evaluate usage related data (e.g., identifying cycle/service life) written to the transmitter or a history of data signals received from the validated component to determine the service or cycle life of the component (block 96). If the service or cycle life exceeds an allowable value (e.g., more than two years in service, more than 1000 operations/actuations), the processor delivers an improper assembly signal to generate a warning signal (block 96a) and/or disables the operating mechanism of the assembly (block 96b). If all of the data signals of the proper, validated trackable components are identified by the processor, and the determined service or cycle life is within an allowable value, the processor permits operation of the operating mechanism without issuing a warning signal (block 97). Monitoring process or logic 90 is configured to run or execute on a microprocessor-based environment and may be stored in various computer-readable mediums

Assembly and/or maintenance monitoring systems, such as those described above, may be used on a variety of assemblies. In one embodiment, as described above, an adjustable bed includes a monitoring system used to identify the inclusion or use of incorrect, outdated or overly worn bed components that may create pinch or entrapment points or gaps between the mattress, side rails, and/or end boards. The monitoring system may be configured to periodically check for invalid, missing, or overly worn components, for example, when the bed is powered on, when operation is initiated (e.g., a pressing of a control button or switch), or at a predetermined time interval (e.g., hourly, daily, weekly).

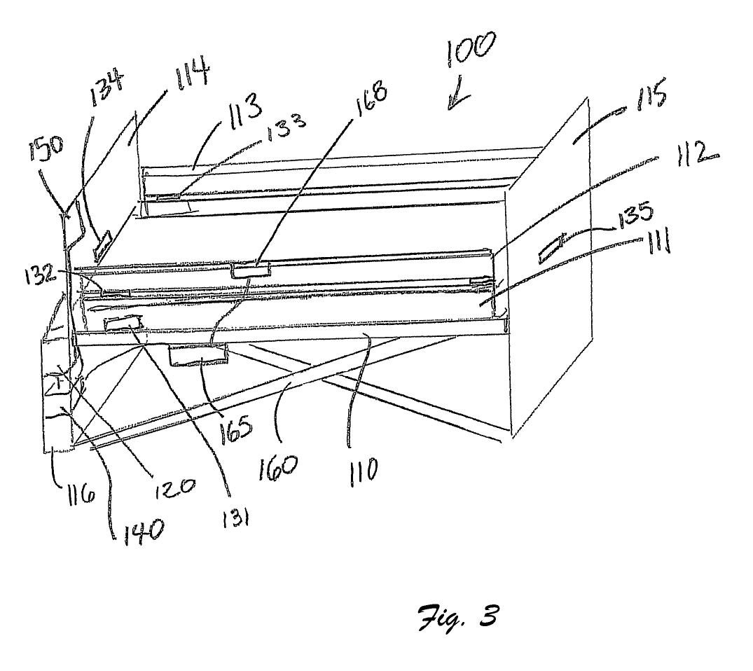

FIG. 3 schematically illustrates an adjustable bed 100 having a monitoring system for identifying and/or preventing hazardous assembly conditions. The bed 100 includes a bed frame 110, mattress 111, side rails 112, 113, a headboard 114, and a footboard 115. In one embodiment, a power control box 116 is assembled with a portion the bed 100 (for example, with the headboard 114) and is electrically connected with a power lift mechanism 160 configured to selectively adjust (e.g., using a remote or wired controller 168) an elevation, angle, or other such configuration of the bed 100. In other embodiments, manually powered lifting mechanisms can be used.

While an assembly and/or maintenance monitoring system may be provided in a device that is separate from the assembly to be monitored, in an exemplary embodiment, a monitoring system may be integrated into an assembly (e.g., an adjustable bed) to monitor a condition of the assembly. In the illustrated embodiment, the power control box 116 includes an RFID reader 120 configured to transmit an RFID signal with a range sufficient to reach one or more trackable components of the bed 100 (e.g., one or more of the mattress 111, side rails 112, 113, headboard 114, and footboard 115). The RFID signal may be limited in range such that trackable components assembled with other, nearby beds are not interrogated. The trackable components of the bed 100 include RFID tags 131, 132, 133, 134, 135 that receive the RFID signals and deliver response signals to the RFID reader 120, including information related to the identity, age, condition of the corresponding component, and/or other information. The RFID reader delivers the information, as data signals, to a processor 140, which evaluates the data signals to compare the received information to expected or required information associated with the trackable components.

The exemplary processor 140 may be programmed for use with a particular bed or beds, identifying components (e.g., mattress, side rails, end boards) of a specific size, material, or other configuration that have been validated or otherwise approved for safe use together in a bed assembly. As new combinations of components become validated or approved, information pertaining to these approved combinations may be stored in the processor. If the processor 140 receives information from the RFID reader 120 that is inconsistent with an approved assembly (e.g., one or more of the trackable component data signals is not received, or a data signal corresponding to an incorrect component is received), the processor may be configured to generate a warning signal (e.g., audible, visible, etc.) through a connected user interface 150 (e.g., a speaker, screen, display panel) to identify the improper assembly. Additionally or alternatively, the processor 140 may be configured to disable or restrict an actuator 165 of the power lift mechanism 160 to prevent operation of the un-validated assembly. Further, if the processor 140 receives information from the RFID reader 120 that suggests excessive wear to a trackable component (e.g., the mattress 111), for example, based on a period of time in service or a number of actuations (e.g., based on repeated interrogation of the same component over a prolonged time period), the processor 140 may be configured to generating a warning through the user interface 150 to identify the need for upcoming, imminent, or immediate replacement of the component. Additionally or alternatively, the processor 140 may be configured to disable or restrict the actuator 165 of the power lift mechanism 160 to prevent operation of the assembly with an excessively worn or improperly maintained component.

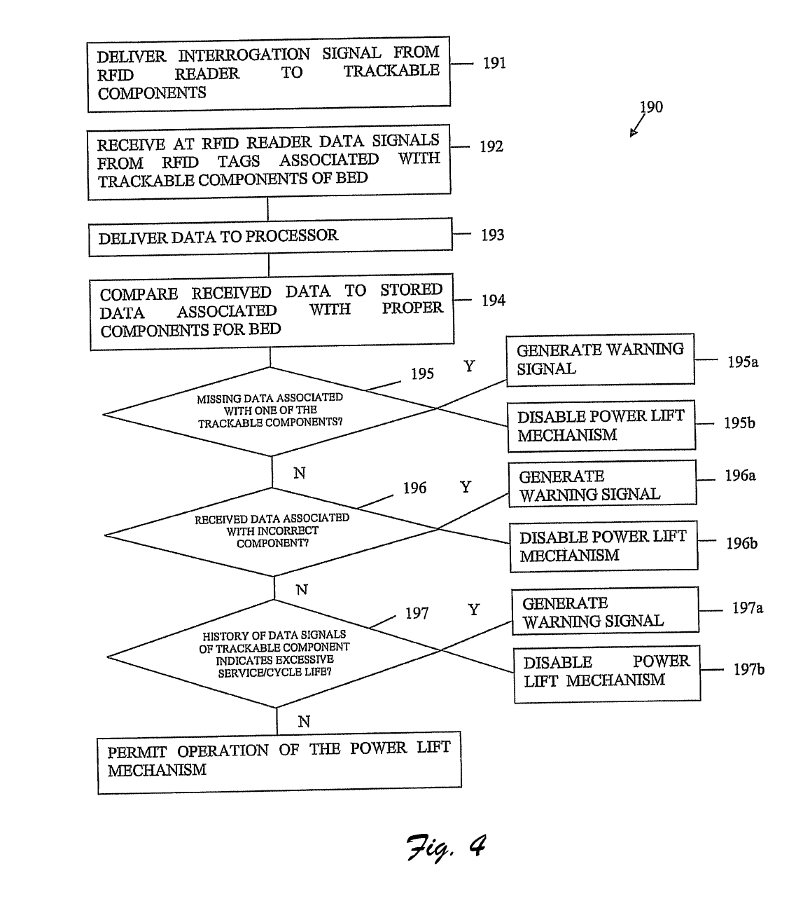

FIG. 4 is a block diagram illustrating an exemplary monitoring process or logic 190 for the exemplary adjustable bed 100 described above. In block 191, the RFID reader in the power control box delivers an interrogation signal to the trackable components (e.g., the mattress, side rails, and end boards) of the bed. In block 192, the trackable components deliver responsive data signals to the RFID reader. In block 193, the RFID reader delivers data obtained from the data signals to the processor. In block 194, the processor compares the received data to stored data associated with validated or proper components or combinations of components for the bed. If the processor fails to receive data associated with one of the trackable components (as queried in block 195), the processor delivers an improper assembly signal to generate a warning signal (block 195a) and/or disable a power lift mechanism (block 195b). If the processor receives data associated with an improper or un-validated trackable component (as queried in block 196), the processor delivers an improper assembly signal to generate a warning signal (block 196a) and/or disable the power lift mechanism of the bed (block 196b). Additionally or alternatively, if the processor receives data confirming assembly with proper or validated components, the processor may evaluate a history of data signals received from the validated component to determine the service or cycle life of the component (block 197). If the service or cycle life exceeds an allowable value (e.g., more than two years in service, more than 1000 operations/actuations), the processor delivers an improper assembly signal to generate a warning signal (block 197a) and/or disable the power lift mechanism of the bed (block 197b). If all of the data signals of the proper, validated trackable components are identified by the processor, and the determined service or cycle life is within an allowable value, the processor permits operation of the power lift mechanism (block 198).

The system and method of the present invention can be implemented on a variety of platforms including, for example, networked computer systems and stand-alone computer systems. Additionally, the logic and databases shown and described herein preferably reside in or on a computer readable medium such as, for example, a Read-Only Memory (ROM), Random-Access Memory (RAM), programmable read-only memory (PROM), electrically programmable read-only memory (EPROM), electrically erasable programmable read-only memory (EEPROM), magnetic disk or tape, and optically readable mediums including CD-ROM and DVD-ROM. Still further, the processes and logic described herein can be merged into one large process flow or divided into many sub-process flows. The order in which the process flows herein have been described is not critical and can be rearranged while still accomplishing the same results. Indeed, the process flows described herein may be rearranged, consolidated, and/or re-organized in their implementation as warranted or desired.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

We claim:

1. An assembly monitoring system comprising:
a receiver;
an assembly comprising at least one trackable component including a transmitter configured to deliver component identifying data to the receiver; and
a processor in electronic communication with the receiver and storing authorized assembly configuration data associated with at least one authorized component, the processor being configured to receive the component identifying data from the receiver and to compare the component identifying data with the authorized assembly configuration data;
wherein the processor is further configured to generate a first improper assembly signal when the component identifying data does not correspond to at least a portion of the authorized assembly configuration data.

2. The system of claim 1, wherein the processor is configured to determine a service life of the at least one trackable component, wherein the processor is configured to generate a second improper assembly signal when the determined service life of the at least one trackable component exceeds a predetermined threshold.

3. The system of claim 2, wherein the processor determines the service life of the at least one trackable component by evaluating a history of received component identifying data from the at least one trackable component.

4. The system of claim 2, wherein the at least one trackable component is configured to store usage identifying data, with the processor determining the service life of the at least one trackable component by evaluating the usage identifying data delivered from the at least one trackable component to the receiver.

5. The system of claim 1, wherein the processor is configured to generate a second improper assembly signal when the receiver fails to receive the component identifying data.

6. The system of claim 1, further comprising a user interface, wherein the processor is configured to deliver the received one of the at least one improper assembly signals to the user interface to generate a warning notification.

7. The system of claim 1, further comprising an electrically powered operating mechanism, wherein the assembly is configured to disable the electrically powered operating mechanism in response to generation of the first improper assembly signal.

8. The system of claim 1, wherein the assembly comprises an electrically powered adjustable bed, wherein the at least one trackable component comprises at least one of a mattress, side rail, and end board.

9. The system of claim 1, wherein the component identifying data identifies at least one of a serial code, date code, product part number, and date of first use.

10. The system of claim 1, wherein at least one of the receiver and the processor is integrated into the assembly.

11. The system of claim 1, further comprising a portable diagnostic device disconnected from the assembly, wherein at least one of the receiver and the processor is integrated into the portable diagnostic device.

12. A method for monitoring an assembly, the method comprising:
receiving component identifying data from a transmitter associated with a first trackable component of the assembly;
delivering the component identifying data to a processor;
comparing the component identifying data to authorized assembly configuration data associated with an authorized component; and
generating a first improper assembly signal when the component identifying data does not correspond to the authorized assembly configuration data.

13. The method of claim 12, further comprising generating a second improper assembly signal in response to a failure to receive the component identifying data associated with the first trackable component.

14. The method of claim 12, further comprising determining, in the processor, a service life of the first trackable component and generating a second improper assembly signal when the determined service life of the first trackable component exceeds a predetermined threshold.

15. The method of claim 14, wherein determining a service life of the first trackable component comprises at least one of evaluating a history of received component identifying data of the first trackable component and evaluating usage identifying data transmitted from the transmitter of the first trackable component.

16. The method of claim 12, further comprising disabling an electrically powered operating mechanism of the assembly in response to generation of the first improper assembly signal.

17. An electrically powered adjustable bed assembly comprising:
first and second side rails;
an end board assembled with end portions of the first and second side rails;
a mattress; and
a first transmitter assembled with one of the first side rail, the second side rail, the end board, and the mattress, wherein the first transmitter is configured to deliver a first wireless signal communicating first component identifying data including at least one of a serial code, date code, product part number, and date of first use of the one of the first side rail, the second side rail, the end board, and the mattress.

18. The assembly of claim 17, further comprising a receiver configured to receive the first component identifying data from the first transmitter, and a processor in electronic communication with the receiver and storing authorized assembly configuration data associated with the one of the first side rail, the second side rail, the end board, and the mattress, the processor being configured to compare the component identifying data with the authorized assembly configuration data, wherein the processor is further configured to generate a first improper assembly signal when the component identifying data does not correspond to at least a portion of the authorized assembly configuration data.

19. The assembly of claim 18, further comprising a power lift mechanism operable to raise and lower the mattress with respect to the end board, wherein the power lift mechanism is configured to be disabled in response to receipt of the first improper assembly signal.

20. The assembly of claim 18, further comprising:
a second transmitter assembled with another one of the first side rail, the second side rail, the end board, and the mattress, wherein the second transmitter is configured to deliver a wireless signal communicating component identifying data including at least one of a serial code, date code, product part number, and date of first use of the other one of the first side rail, the second side rail, the end board, and the mattress;
a receiver configured to receive the first and second component identifying data from the first and second transmitters, and
a processor in electronic communication with the receiver and storing authorized assembly configuration data associated with the assembly, the processor being configured to compare the first and second component identifying data with the authorized assembly configuration data, wherein the processor is further configured to generate a first improper assembly signal when the first and second component identifying data indicates an improper assembly.
